(19) United States
(12) Patent Application Publication
(10) Pub. No.: US 2015/0199756 A1
(43) Pub. Date: Jul. 16, 2015

(54) LINKING LOGIC FEATURE

(71) Applicant: Bank of America Corporation, Charlotte, NC (US)

(72) Inventors: Richard Hardin Staton, Broomall, PA (US); Hari Madala, Pittsburgh, PA (US); John J. Gately, New Port Richey, FL (US); Hung Quang Pham, Kennesaw, GA (US); Patrick B. Smith, Garland, TX (US); Pushpanjali Kottapalli, Morris Plains, NJ (US)

(73) Assignee: Bank of America Corporation, Charlotte, NC (US)

(21) Appl. No.: 14/152,256

(22) Filed: Jan. 10, 2014

(51) Int. Cl. G06Q 40/02; G06F 17/30

(52) U.S. Cl. CPC G06Q 40/02; G06F 17/30598

(57) ABSTRACT

Embodiments for linking account data are included in systems for receiving account data and non-account data and filtering the account data by customer or account information. The embodiments further include identifying a customer and customer accounts based on the filtered account data and linking at least a portion of the non-account data to the customer, and combining the non-account data portion and the filtered account data, and identifying one or more guarantors of the customer accounts based on the combined data.

### BACKGROUND

Many companies have many different customer accounts and a large amount of data associated with the accounts. Often, the accounts are analyzed and grouped separately such that all of the data associated with the account or the account holder is not fully exposed or utilized.

### BRIEF SUMMARY

The embodiments provided herein are directed to systems for linking, analyzing, and processing account data. In some embodiments, the systems include a computer apparatus including a processor and a memory and a linking logic module stored in the memory, comprising executable instructions that when executed by the processor cause the processor to receive account data and non-account data. In some embodiments, the executable instructions further cause the processor to filter the account data by customer identification or account identification. In some embodiments, the executable instructions further cause the processor to identify a customer and customer accounts associated with the customer based on the filtered account data. In some embodiments, the executable instructions further cause the processor to link at least a portion of the non-account data to the customer and combine the non-account data portion and the filtered account data. In some embodiments, the executable instructions further cause the processor to identify one or more guarantors of the customer accounts based on the combined data.

In other embodiments of the systems, the executable instructions further cause the processor to identify portions of the combined data unrelated to the one or more guarantors; and filter the identified portions from the combined data. In additional embodiments of the systems, the executable instructions further cause the processor to re-filter the account data based on the one or more guarantors; identify at least one additional account associated with the one or more guarantors; identify an additional guarantor for the at least one additional account; and determine that the additional guarantor is financially responsible for at least a portion of payments for the customer accounts. In some embodiments of the systems, the executable instructions further cause the processor to identify a change in customer status; calculate increases or decreases in inbound or outbound transaction amounts; and determine the amount owed by each of the one or more guarantors based on the calculated increased or decreased amounts.

In additional embodiments of the systems, the executable instructions further cause the processor to match a segment of the filtered account data to a segment of the non-account data portion; determine the number of matches and type of matches; and calculate a connection rating based on the number of matches and the type of matches, wherein the filtered account data and the non-account data portion are combined based on the connection rating. In other embodiments, the executable instructions further cause the processor to calculate the amount each of the one or more guarantors owes based on the combined data; prioritize the one or more guarantors based on the amount owed; and create a payment recovery strategy based on the guarantor priority.

In further embodiments of the systems, the executable instructions further cause the processor to prompt the customer to confirm the identity of the one or more guarantors. In some embodiments, the executable instructions further cause the processor to identify account criteria of other accounts associated with one or more different customers, the account criteria comprising account balances, geographical locations, and account types. In other embodiments, the executable instructions further cause the processor to compare the account criteria of the other accounts and the customer accounts; determine that the other accounts are substantially similar to the customer accounts based on the comparison; and identify a second guarantor associated with at least one of the other accounts. In still other embodiments, the executable instructions further cause the processor to assign the second guarantor to the customer accounts based on the similarity between the other accounts and the customer accounts. In some embodiments, the executable instructions further cause the processor to calculate the percentage of the other accounts that have the second guarantor; determine that the percentage is above a preselected threshold; assign the other accounts' guarantor to the customer accounts based on the threshold determination.

Further provided herein are embodiments directed to a computer program product for systems for linking, analyzing, and processing account data. In some embodiments, the computer program product comprises a computer readable storage medium having computer readable program code embodied therewith, the computer readable program code comprising computer readable program code configured to receive account and non-account data. In some embodiments, the computer program product further includes computer readable program code configured to filter the account data by customer identification or account identification. In some embodiments, the computer program product further includes computer readable program code configured to identify a customer and customer accounts associated with the customer based on the filtered account data. In some embodiments, the computer program product further includes computer readable program code configured to link at least a portion of the non-account data to the customer and combine the non-account data portion and the filtered account data. In some embodiments, the computer program product further includes computer readable program code configured to identify one or more guarantors of the customer accounts based on the combined data.

In further embodiments, the computer program product further includes computer readable program code configured to identify portions of the combined data unrelated to the one or more guarantors; and filter the identified portions from the combined data. In other embodiments, the computer program product further includes computer readable program code configured to re-filter the account data based on the one or more guarantors; identify at least one additional account associated with the one or more guarantors; identify an additional guarantor for the at least one additional account; and determine that the additional guarantor is financially responsible for at least a portion of payments for the customer accounts.

In some embodiments, the computer program product further includes computer readable program code configured to identify a change in customer status; calculate increases or decreases in inbound or outbound transaction amounts; and determine the amount owed by each of the one or more guarantors based on the calculated increased or decreased amounts. In other embodiments, the computer program product further includes computer readable program code configured to match a segment of the filtered account data to a segment of the non-account data portion; determine the number of matches and type of matches; and calculate a connection rating based on the number of matches and the type of matches, wherein the filtered account data and the non-account data portion are combined based on the connection rating. In additional embodiments, the computer program product further includes computer readable program code configured to calculate the amount each of the one or more guarantors owes based on the combined data; prioritize the one or more guarantors based on the amount owed; and create a payment recovery strategy based on the guarantor priority.

In additional embodiments, a computer-implemented method for linking, analyzing, and processing account data is provided. In some embodiments, the method includes receiving account data and non-account data. In some embodiments, the method includes filtering, by a processor, the account data by customer identification or account identification. In some embodiments, the method includes identifying, by a processor, a customer and customer accounts associated with the customer based on the filtered account data. In some embodiments, the method includes linking, by a processor, at least a portion of the non-account data to the customer and combining the non-account data portion and the filtered account data. In some embodiments, the method includes identifying, by a processor, one or more guarantors of the customer accounts based on the combined data.

In additional embodiments of the method, the method includes identifying portions of the combined data unrelated to the one or more guarantors; and filtering, by a processor, the identified portions from the combined data. In other embodiments of the method, the method includes re-filtering, by a processor, the account data based on the one or more guarantors; identifying at least one additional account associated with the one or more guarantors; identifying an additional guarantor for the at least one additional account; and determining that the additional guarantor is financially responsible for at least a portion of payments for the customer accounts. In still other embodiments of the method, the method includes calculating, by a processor, the amount each of the one or more guarantors owes based on the combined data; prioritizing the one or more guarantors based on the amount owed; and creating a payment recovery strategy based on the guarantor priority.

### BRIEF DESCRIPTION OF THE SEVERAL VIEWS OF THE DRAWINGS

The present embodiments are further described in the detailed description which follows in reference to the noted plurality of drawings by way of non-limiting examples of the present embodiments in which like reference numerals represent similar parts throughout the several views of the drawings and wherein:

FIG. 1 provides a block diagram illustrating a system and environment for linking account data;

FIG. 2 is a flowchart illustrating a system and method for linking, analyzing, and processing account data in accordance with various embodiments;

FIG. 3 is a flowchart illustrating a system and method for linking, analyzing, and processing account data in accordance with various embodiments; and

FIG. 4 is an illustration of a graphical user interface systems for linking, analyzing, and processing account data in accordance with various embodiments.

### DETAILED DESCRIPTION

The embodiments presented herein are directed to systems, methods, and computer program products for linking, analyzing, and processing account data. Systems analyze many types of accounts across a wide array of relationships to map customer accounts to a specific relationship. In some embodiments, accounts are linked based on guarantors rather than based on “owners” or a household. The system links all account of an entity that are in arrears together and identifies guarantors for each account. In some cases, the system pulls together internal and external data to identify guarantors for each customer account and filters out data unrelated to the guarantors. This allows the system to produce a more focused and detailed relationship overview for enhancing payment recovery processing.

The embodiments of the disclosure may be embodied as a system, method, or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present embodiments of the disclosure may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing. Computer program code for carrying out operations for aspects of the present embodiments of the disclosure may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present embodiments of the disclosure are described below with reference to flowchart illustrations and/or block diagrams of methods, apparatus (systems) and computer program products according to embodiments of the embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

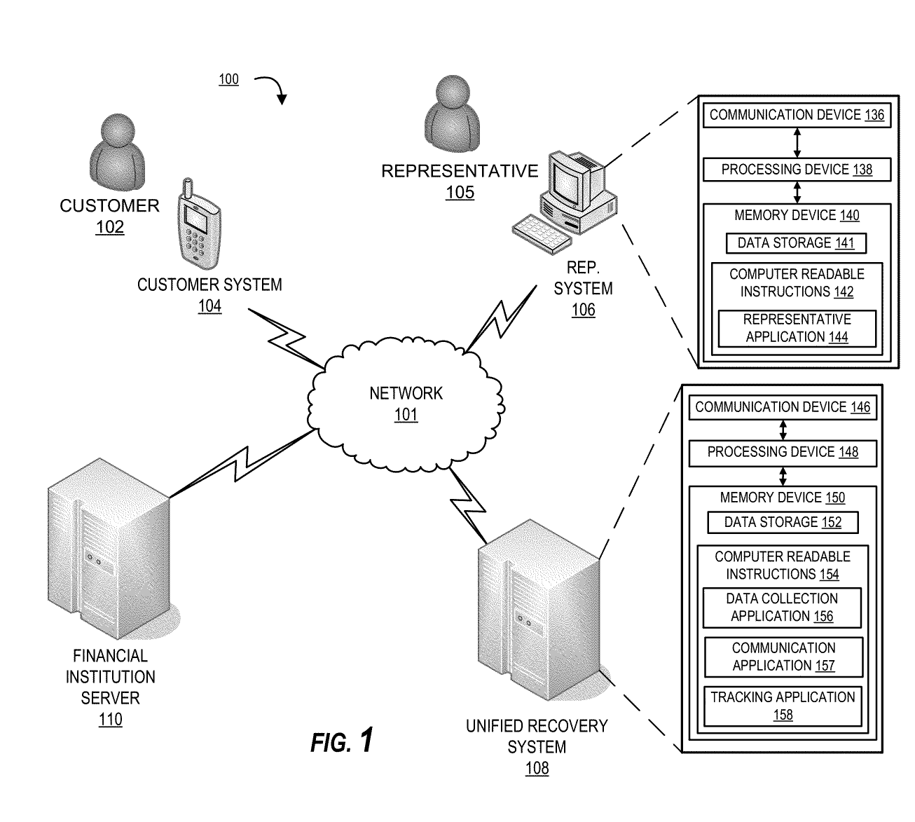

FIG. 1 provides a unified recovery system environment 100, in accordance with embodiments of the present invention. As illustrated in FIG. 1, the unified recover system 108 is operatively coupled, via a network 101 to a customer system 104, to a representative system 106, and to a financial institution server 110. In this way, the unified recovery system 108 can send information to and receive information from the customer system 104, the representative system 106, and financial institution server 110, to correlate all of the customer's relationships with an entity into one unified recovery system. FIG. 1 illustrates only one example of an embodiment of a unified recovery system environment 100, and it will be appreciated that in other embodiments one or more of the systems, devices, or servers may be combined into a single system, device, or server, or be made up of multiple systems, devices, or servers.

The network 101 may be a global area network (GAN), such as the Internet, a wide area network (WAN), a local area network (LAN), or any other type of network or combination of networks. The network 101 may provide for wireline, wireless, or a combination wireline and wireless communication between devices on the network 101.

In some embodiments, the customer 102 is an individual who has products with the entity. These products may be one or more contracts, accounts, loans, transactions, agreements, or the like. As such, the customer 102 may have one or more products with payments in arrears. In some embodiments, the customer 102 may be a merchant or a person, employee, agent, independent contractor, and the like acting on behalf of the merchant that may have one or more products with payments in arrears with the entity.

As illustrated in FIG. 1, a unified recovery system 108 generally comprises a communication device 146, a processing device 148, and a memory device 150. As used herein, the term “processing device” generally includes circuitry used for implementing the communication and/or logic functions of the particular system. For example, a processing device may include a digital signal processor device, a microprocessor device, and various analog-to-digital converters, digital-to-analog converters, and other support circuits and/or combinations of the foregoing. Control and signal processing functions of the system are allocated between these processing devices according to their respective capabilities. The processing device may include functionality to operate one or more software programs based on computer-readable instructions thereof, which may be stored in a memory device.

The processing device 148 is operatively coupled to the communication device 146 and the memory device 150. The processing device 148 uses the communication device 146 to communicate with the network 101 and other devices on the network 101, such as, but not limited to a representative system 106, a customer system 104, and a financial institution server 110. As such, the communication device 146 generally comprises a modem, server, or other device for communicating with other devices on a network 101.

As further illustrated in FIG. 1, the unified recovery system 108 comprises computer-readable instructions 154 stored in the memory device 150, which in one embodiment includes the computer-readable instructions 154 of a data collection application 156. In some embodiments, the computer-readable instructions 154 include a communication application 157. In some embodiments, the computer-readable instructions 154 include a tracking application 158. In still further embodiments, the computer-readable instructions 154 include a linking logic application (not shown) for performing the embodiments described herein. In some embodiments, the memory device 150 includes data storage 152 for storing data related to unified recovery system including but not limited to data created and/or used by the data collection application 156, communication application 157, and/or tracking application 158.

In the embodiment illustrated in FIG. 1, the data collection application 156 may collect and compile recover programs utilized across the entity, customer relationship data across an entity, and to generate a centralized location for customer data. In some embodiments, the data collection application 156 may collect and compile recovery products utilized across the entity into a single centralized unified recovery system 108. These may be collected from entity representative systems 106, the financial institution server 110, and/or other systems. These recover products may be internal or external dockets, ledgers, software, systems, or the like that are designed to initiate, monitor, and record any communication or payment associated with customer 102 products in arrears. In further embodiments, the data collection application 156 may collect and compile customer relationship data. In this way, the data collection application 156 may compile all information that an entity may have associated with a customer 102. Customer relationship data may include, but is not limited to addresses associated with a customer, customer contact information, customer associate information, customer products, customer products in arrears, or other information associated with the customer's one or more accounts, loans, products, purchases, agreements, or contracts that a customer may have with the entity. In other embodiments, the data collection application 156 may merge the recovery programs and the customer relationship data together into the unified recovery system 108. This data may be stored grouped by on the customer 102, customer identification number, account number, or telephone number. In this way, the system may generate a single centralized location for customer relationships for a representative to view and interact with. As such, any different recovery products and customer relationship data may be integrated into the one centralized unified recovery system.

In the embodiment illustrated in FIG. 1 the unified recovery system 108 further comprises a communication application 157. The communication application 157 allows for presentment of data to the representative, for rules determination and presentment, determines lead accounts, and for communication via a network 101 with the customer 102. In some embodiments, the communication application 157 allows for presentment of data to the representative. This data may be customer 102 information, prior communications, communication dispositions, current accounts, accounts in arrears, lead accounts, and the like. In this way, the representative may have information associated with all customer relationships within the entity easily accessible for his/her communication with the customer 102. In some embodiments, the communication application 157 allows for incorporation of a rules engine into the information provided to the representative. In some embodiments, the rules associated with the rules engine may be manually inputted by a representative. In some embodiments, the rules associated with the rules engine may be automatically inputted. In some embodiments, the rules may be based on entity requirements or preferences. In some embodiments, the rules may be based on customer preferences. In yet other embodiments, the rules may be based on legal requirements or restrictions. These rules may be communicated to the representative system 106 for the representative 105 from the communication application 157 via the network 101. In this way, the representative 105 may be aware of the rules for customer 102 communications.

Along with the rules, the communication application 157 may also determine a lead account associated with the customer 102, identify an appropriate representative 106, warn or prohibit communications to a customer 102, or require disposition input after a communication. Determining a lead account requires the communication application 157 to communicate with the financial institution server 110 to select an account in arrears that is most important for the entity to recover. Selecting an appropriate representative may be achieved by the communication application 157 based on which representative has experience with that particular customer, knowledge with that particular lead account, or general expertise regarding a field associated with the lead account. The communication application 157 may communicate warning or prohibiting communications to a customer 102 via the network 101 to a representative system 106.

In some embodiments, the communication application 157 may allow for representative 105 communications with the customer 102 via the network 101. In this way, the communication application 157 allows for the communication, limits the communication, and/or doesn't allow any communication based on the rules determined. In the embodiment illustrated in FIG. 1, the unified recovery system 108 further comprises a tracking application 158. The tracking application 158 tracks the communications of customer 102. As such, dates, times, outcomes, responses, dispositions, or the like associated with each and every attempt to contact the customer 102. In this way, the system may track whether a communication went through to the customer, whom the representative spoke to, the duration of the communication, time of communication, date of communication, or the like.

As illustrated in FIG. 1, a representative 105 may be an individual customer service representative for an entity, an operator, and the like. In some embodiments the representative 105 may be an individual employed by the entity. In some embodiments, the representative 105 may be an outside contractor for the entity. The representative 105 may have unique skills or experience with recovery payments in arrears for various products associated with products provided by the entity.

As illustrated in FIG. 1, the representative system 106 generally comprises a communication device 136, a processing device 138, and a memory device 140. The processing device 138 is operatively coupled to the communication device 136 and the memory device 140. In some embodiments, the processing device 138 may send or receive data from the customer system 104, financial institution server 110, and/or the unified recover system 108 via the communication device 136 over a network 101. As such, the communication device 136 generally comprises a modem, server, or other device for communicating with other devices on the network 101.

As further illustrated in FIG. 1, the representative system 106 comprises computer-readable instructions 142 stored in the memory device 140, which in one embodiment includes the computer-readable instructions 142 of a representative application 144. In the embodiment illustrated in FIG. 1, the representative application 144 allows the representative system 106 to be linked to the unified recovery system 108 to communicate, via a network 101, the information related to the communications with a customer 102 related to products with payments in arrears. In some embodiments, the communication from the representative 105, such as communication inputted on the unified application by the representative 105, may be communicated to the unified recover system 108 via the communication device 136. The representative application 144 may also allow the representative to receive data, such as the unified application including customer relationships, or the like, in order to communicate with the customer. The memory device 140 further includes a data storage device 141.

FIG. 1 also illustrates a customer system 104. The customer system 104 generally comprises systems with devices the same or similar to the devices described for the unified recovery system 108, and/or the representative system 106 (i.e., communication device, processing device, and memory device). Therefore, the customer system 104 may communicate with the unified recovery system 108, the representative system 106, and/or the financial institution server 110 in the same or similar way as previously described with respect to each system. The customer system 104, in some embodiments, is comprised of systems and devices that allow the customer 102 to communicate with the representative 105 over a network 101. The customer system 104 may be, for example, a home phone, a desktop personal computer, a mobile system, such as a cellular phone, smart phone, personal data assistant (PDA), laptop, or the like. Although only a single customer system 104 is depicted in FIG. 1, the unified recovery system environment 100 may contain numerous customer systems 104.

The financial institution server 110 is operatively coupled to the unified recovery system 108, the representative system 106, and/or the customer system 104 through the network 101. The financial institution server 110 has systems with devices the same or similar to the devices described for the unified recovery system 108 and the representative system 106 (i.e., communication device, processing device, and memory device). Therefore, the financial institution server 110 communicate with the unified recovery system 108, the representative system 106, and/or the customer system 104 in the same or similar way as previously described with respect to each system. The financial institution server 110, in some embodiments, is comprised of systems and devices that allow the unified recover system 108, the representative system 106, and the customer system 104 access to one or more accounts associated with the customer 102 with the financial institution.

It is understood that the servers, systems, and devices described herein illustrate one embodiment of the invention. It is further understood that one or more of the servers, systems, and devices can be combined in other embodiments and still function in the same or similar way as the embodiments described herein.

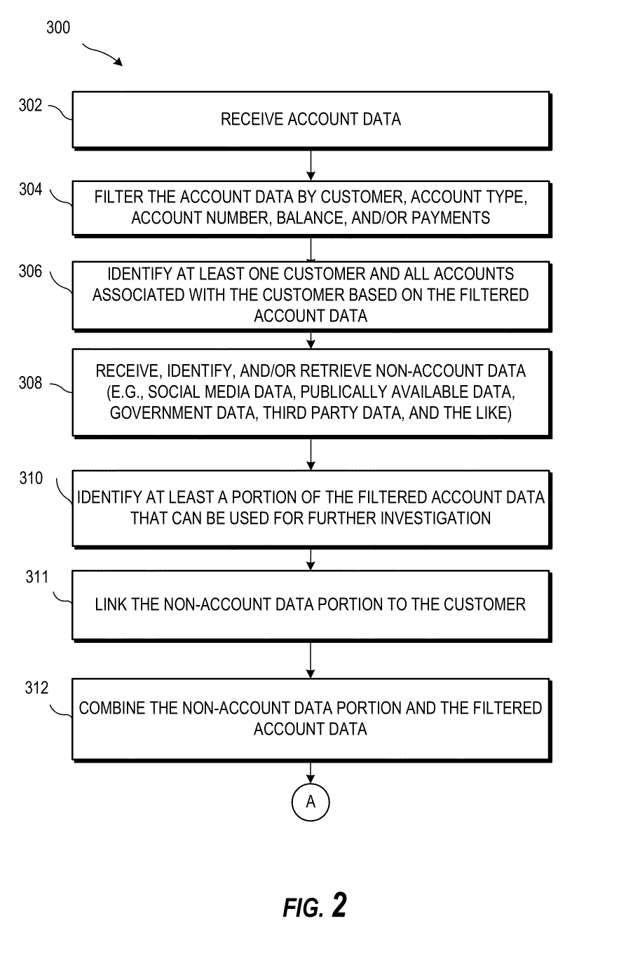

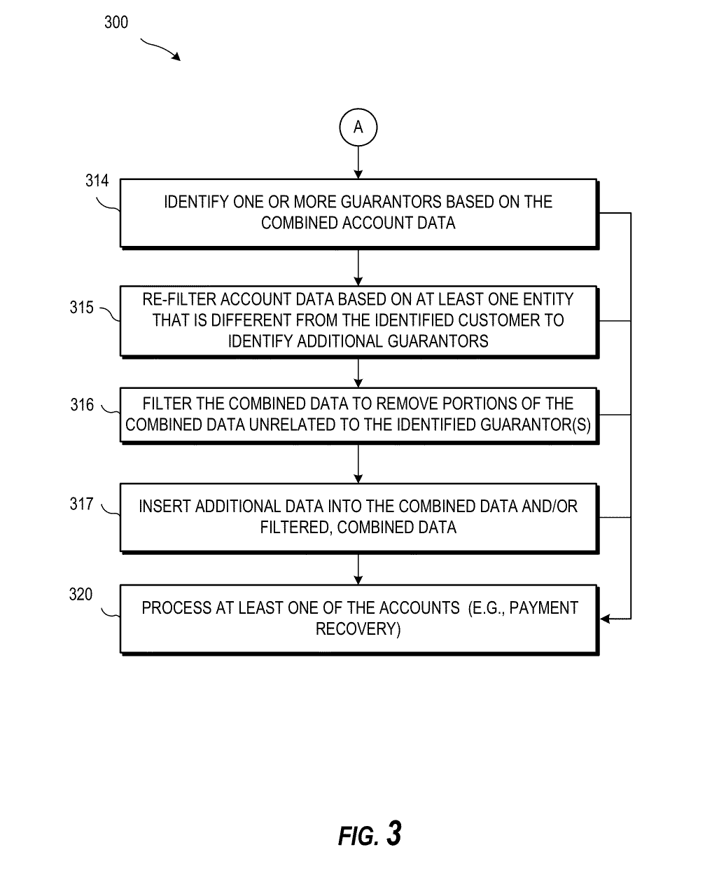

FIGS. 2-3 illustrate flowcharts providing an overview of a process 300 for linking, analyzing, and processing account data. One or more devices, such as the one or more devices and/or one or more other computing devices and/or servers of FIG. 1, can be configured to perform one or more steps of the process 300 described below. In some embodiments, the one or more devices performing the steps are associated with a financial institution. In other embodiments, the one or more devices performing the steps are associated with a merchant, business, partner, third party, credit agency, account holder, and/or user. As provided herein, it will be understood that the process of FIGS. 2-3 is merely an exemplary embodiment and that the various steps of process 300 can be conducted in any order.

As illustrated at block 302, account data is received. The account data is received from customers, online banking accounts, third party financial institutions, government entities, business entities, merchants, and the like. In some embodiments, the account data comprises information from one or more accounts associated with one or more clients, customers, account holders, and/or guarantors. Exemplary account data includes account numbers, phone numbers associated with the account, balances, current payments due dates, previous payment due dates, payment history, available balance amounts, interest rates, types of account, accounts associated with the account customer (e.g., a grouping of accounts designated with an internal ID), age of account, regulations associated with the account, call history associated with the account, customer input data associated with account customers, and so forth.

As illustrated at block 304, the account data is filtered by customer (e.g., name or other customer identifier), account number, account type, balance amount, and/or payments (e.g., payment history, current payment due dates, and/or previous payment due dates). In some embodiments, account data related to a particular customer (or more than one customer) are grouped together and unrelated data is removed. In other cases, the account data is grouped by account number, account type, balance amount, and or payments. In this way, an account specialist or representative can easily search and cross-search through one or more databases to identify all account data for a particular customer, account, and so forth. In other cases, the account data is filtered and/or grouped automatically by the system of process 300. For example, algorithms, operators, Boolean, key terms, and the like can be used to identify related data in one or more databases. In other embodiments, the accounts are filtered by guarantor. It is understood that the customer, in some embodiments comprises a guarantor.

As illustrated at block 306, at least one customer and all accounts related to the at least one customer are identified based on the filtered data. The at least one customer includes, for example, single account holders, joint account holders, primary customers, secondary customers, guarantors, and the like. The accounts include financial accounts, financial products, product accounts, online banking accounts, non-financial accounts (e.g., social media, group membership, or blogging accounts), and so forth. The accounts associated with the identified customer include individual accounts, joint account, group accounts, or financial products at least partially held by the customer. In other embodiments, the customer is a co-signer to a financial product, a party to a contract or other obligation, a guarantor, and the like. The customer may or may not be under a financial obligation under the terms of the account.

In some embodiments, the customer or the customer's identification is cross searched with one or more databases. For example, the filtered data may be segmented by the filter criteria and stored in databases that are later cross referenced to identify correlations with the customer data. In other examples, a customer name, customer identification, customer address, and/or other customer data is matched to account data in one or more databases. In additional embodiments, all identified account data related to a customer's name or other customer data are searched to determine the accounts associated with the customer. In other embodiments, only some of the accounts associated with the customer are identified. For example, the process in step 306 may only identify internal accounts and not external accounts, or may not identify account where the customer is not specifically listed as an account holder (e.g., the customer is an agent of the account holder). In such cases, external data such as the non-account data described below can be used to identify additional accounts associated with the at least one customer.

As illustrated at block 308, non-account data is received, identified, and/or retrieved. The non-account data includes online data, publically available data, input data (e.g., data received from the identified customer, agent of the customer, merchant, third party bank, and the like), government data, other third party data, and the like. Exemplary non-account data includes settlements, court proceedings, judgments, government records, blog posts, social media data, identifications, real estate data, licenses, certifications, membership lists, publically posted biographies, product reviews, photos, audio recordings, video recordings, and the like. In some embodiments, the non-account data is submitted or approved by the customer. For example, the customer may either share non-account data or opt into a program that enables the system of process 300 to gather or receive the non-account data. It will be understood that all account data and non-account data is used in compliance with internal and external privacy rules as well as applicable law.

As illustrated at block 310, at least a portion of the filtered account data that can be used for further investigation is identified. For example, the customer's geographic location, transaction data associated with the customer's accounts, employment data, total number of accounts, types of accounts, rewards programs, and so forth can be matched to the non-account data. In some cases, customer demographic data such as age groups, marital status, family size, family income, of occupation can be used to determine the likelihood of matching filtered account data portion to some of the non-account data. By examining the demographic data of customers and other account data, a matching strategy can be formulated. For example, customers under the age of 28 may be 85% more likely to be associated with certain social media accounts that customers over the age of 45.

As illustrated at block 311, the portion of the non-account data is linked to the customer. For example, if a customer lives in New York City and has bought photography equipment several times over the past year, then the customer may be linked to a website for a New York City based photography festival associated with the customer, which may identify insurance companies used by members of the website. Such insurance information can be used to determine if a customer has insurance to cover payments for example. In other examples, changes in the identified accounts associated with the customers may be used to link the non-account data to the customer. Customer changes such as account upgrades/downgrades, dropped insurance coverage, marital status changes, name changes, family changes, or phone carrier switches can be matched to public records (e.g., birth certificates, marriage licenses, titles, tax records, newspaper announcements), product or service reviews of the customer, and so forth. Such matching can be used to confirm account changes, extract additional details, and so forth.

As illustrated at block 312, the filtered account data and the non-account data portion are combined. A connection rating is calculated, in some embodiments, to determine whether the account data and non-account data portion should be combined. A higher degree of connectivity corresponds to a higher degree of certainty in the linking of the customer and the non-account data and vice versa. For example, if the customer has an account that includes a credit card reward program and the customer is also a mutual funds account beneficiary, the identified customer's publically available blog posts that rates the same mutual fund in the mutual funds account and the same credit card reward program may be given a rating of 2 for each point of connection between the sets of data. Some matches or connections may be more heavily weighted than others. For example, if a social media post identifies the contributor (e.g., the first name, last name, and middle initial) and also lists the city in which the contributor lives, exact matches of the customer name and the social media contributor name will be rated with a higher degree of connection (e.g., 1.3) than an exact match between cities (e.g., 1.05). Further, accounts that are considered to be more critical such as accounts that have account balances over $50,000 or that have at least 90 day old payment due dates may have a higher calculated connection rating than less critical accounts for the same type of matches.

Referring now to FIG. 3, the process 300 is further illustrated. As illustrated at block 314, one or more guarantors are identified based on the combined account data. The one or more guarantors can be identified based solely on the filtered account data, the non-account data portion, or the combined data. For example, the filtered account data may include terms of a contract, account policies, or law that indicate the identity of the entity financially responsible for the account. In other examples, the guarantor may be based on the transactions associated with the customer's accounts. Purchases of a particular product such as a service or product may have a manufacture or third party warranty or guaranty. In other cases, a contact related to the customer may not be listed as a guarantor, but non-account data such as social media feed or phone book entries can be used to identify the contact as the customer's guardian. In further examples, a business entity on the account may be linked to the owner of the business, a subsidiary, a joint venture, and/or the parent company via the government or company websites, news media data, or other non-account data.

As used herein, “guarantors” include but are not limited to entities that are under an obligation to the customer or to the account. In some embodiments, the one or more guarantors are financially responsible for at least a portion of payments associated with the customer's account. The customer and the one or more guarantors may be the same entity and/or different entities. The guarantors can have full financial responsibility for the account or only partial responsibility. For example an account owner may only be obligated to make 50% of the payments and an insurer may be obligated to make up the difference. In other embodiments, an account holder may be a student or a minor and under no obligation to make payments, and the co-signer of contracts associated with the account such as a parent may be the guarantor.

As illustrated at block 315, the account data is re-filtered to identify additional guarantors based on at least one entity that is different from the identified customer such as non-customers, parties not listed in the customer's accounts, at least one guarantor, third party banks, insurance companies, and the like. For example, the account data may be filtered by a guarantor listed on the identified customer accounts to identify additional accounts associated with the listed guarantor that are not otherwise associated with the customer. An insurance company associated with the customer, for example, may be associated with other accounts, other customers, or other guarantors and data from the other account or entities can be used to identify additional guarantors of the customer accounts. In such cases, metrics of the re-filtered account data are calculated to identify one or more additional guarantors. In a particular example, if a particular entity is listed as a guarantor for a known guarantor of the customer on over 55%-100% of the known guarantor's accounts, then the system of process 300 may determine that the particular entity is also the customer's guarantor. In other cases, the second entity may be confirmed as a guarantor of the customer's accounts using account data, non-account data, combined data, guarantor input, or user input. For example, the known guarantor of the customer may be prompted to confirm that the particular entity is also the guarantor of the customer's accounts. In another example, a parent company of a business entity can also be a guarantor for accounts for which the business entity is a guarantor.

In other embodiments, the customer's accounts are directly compared to other accounts. In some embodiments, account criteria for other accounts associated with one or more different customers (or customers of a third party) are identified. The account criteria includes, for example, account balances, account types, geographical locations of the one or more different customers, and the like. In further embodiments, the customer accounts and the other accounts are compared to determine that the other accounts and the customer accounts are substantially similar. For example, the other accounts and the customer accounts may be considered to be substantially similar if they are all checking accounts, have account balances between $10,000 and $25,000, and are all over three years old. A second guarantor associated with the other accounts, in some embodiments, is identified and assigned to the customer accounts based on the similarity between the customer account and the other accounts, or based on a calculated percentage threshold. For example, if a particular entity is listed as a guarantor for accounts that are similar in type or balance amount as the customer's account, then the system of process 300 may use data of the similar accounts to identify the one or more guarantors of the customer's accounts. If 90% of accounts that have the same range of loan amounts for housing construction in a particular neighborhood list a particular entity (e.g., a builder) as the guarantor, that entity may be contacted to confirm that it is the guarantor of the customer's accounts. In other cases, non-account data can be used to make the confirmation.

In additional embodiments, the combined data is analyzed to identify other accounts associated with the one or more guarantors and extract data from the other accounts. Account balances, contact data, status, and/or historical data of accounts owned by the guarantor may be extracted and included in the combined data or filtered account data in order to gain a more detailed overview of the customer's accounts. Such details can aid in processing the customer's accounts as discussed below.

As illustrated at block 316, the combined data is filtered to remove portions of the combined data unrelated to the identified guarantors. In this way, only the most pertinent information related to payment recovery is retained such that more effective and efficient account analysis can be conducted. Data unrelated to the identified guarantors may include names, contact information, memos, and so forth of entities associated with the account that are not partially or completely financial responsible for the customer's accounts. For example, the account may list the customer's employer and the employer's phone number as an alternative method of reaching the customer, but the employer may not be a guarantor and thus such data may be removed from the combined data.

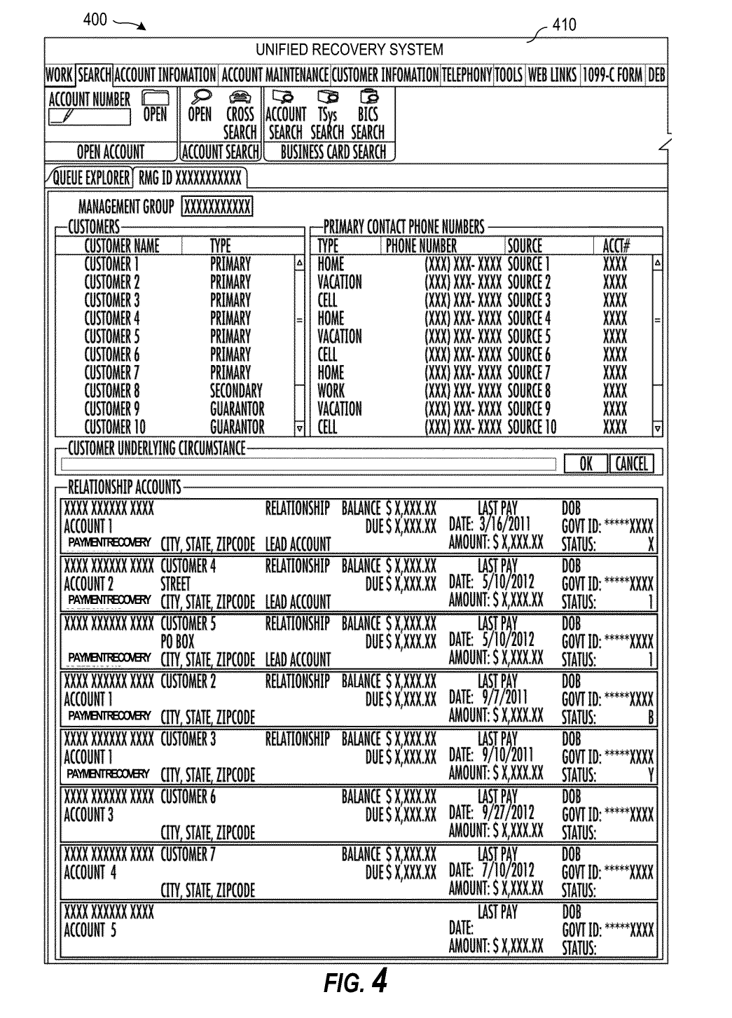

By identifying guarantors for each account, the systems of process 300 can link and define the customer accounts by the guarantors. In some embodiments, the accounts are linked by a single identifier such as a party identification (e.g., a number, alphanumeric string, and so forth) for grouping accounts. The party ID may be assigned to account grouped by customer and/or guarantor. For example, the party ID may be assigned to a group where all accounts related to a particular customer including accounts for which the customer is an account holder, as well as accounts for which the customer is a guarantor. In such grouping, the customer may be the account holder and the guarantor, the account holder but not the guarantor, and/or the guarantor but not the account holder. In cases where the party ID is assigned to account groups based on the guarantor, the guarantor may not be a customer or account holder. In other cases, the guarantor may also be a customer or account holder. An exemplary party ID is illustrated in FIG. 4 as an “RMG ID.”

As illustrated at block 317, in additional or alternative embodiments, additional data is inserted into the combined data and/or the filtered, combined data. Exemplary added data includes memos, reports, calculations, rules, and the like that further enhance the combined data. The additional data may be related or unrelated to the identified guarantors. Exemplary additional data include business mergers and acquisitions, legal status changes, births, deaths, contact changes, domicile changes, and the like. Such changes in the customer's status can be used to calculate increases or decrease in inbound or outbound transaction amounts. For example, if the customer's job status has recently changed (e.g., promoted, became self-employed, and/or changed employers), reports, calculation, or rules related to the customer's new job such as changes in annual pay, automatic pay deposits, or taxes may be included in the combined data or the filtered, combined data. In some embodiments, the calculated increased or decreased transaction amounts are used to determine the amount owed by each of the identified guarantors. For example if the account balance of one of the customer's accounts falls below a certain level due to decreases in inbound transaction amounts or increases in outbound transaction amounts, then the amount owed by the customer may decrease and the amount owed by another guarantor of the customer accounts (e.g., a joint account holder) may increase.

As illustrated at block 320, at least one of the identified accounts is processed. Exemplary processing includes contacting customers or guarantors, recovering payments, upgrading accounts, increasing or decreasing interest rates, archiving, tracking, creating and/or providing notifications, providing offers, initiating balance transfers, redeeming rewards, creating payment strategies, and so forth. In some embodiments, the combined data is used to calculate the amount owed by each of the identified guarantors. Based on the calculated amount owed by each of the guarantors, a dialing campaign, a payment recovery strategy, account tool suggestions, and the like can be created. For example, the guarantors may be prioritized by the amount owed. Prioritization of the identified guarantors of the customer accounts may also be based on the payment history, dialing frequency, or geographic location of the guarantor. The guarantors that owe the most or the guarantor with the most recent payment may be contacted last. In other examples, guarantors that have been contacted the least number of times or that are in a certain time zone may be contacted first.

In further embodiments, the filtered, combined data is provided to a customer service representative or operator for further processing. For payment recovery, the operator may use the filtered, combined account data to determine a guarantor contact strategy or dialing order, create a payment plan for the one or more guarantors, contact the guarantors, calculate the payment amount each of the one or more guarantors is obligated to pay, identify upgrades and/or policy changes to the customer's accounts, identify customer incentives, match the account to new products, and so forth. In other embodiments, processing is done automatically based on the filtered, combined data. For example, the guarantor's contact data may be extracted from the filtered, combined data to initiate an automatic dialing campaign. In still other embodiments data unrelated to the one or more guarantors may be recombined with the filtered, combined data for processing or not filtered from the combined data. In situations where the process includes offering new products, account upgrades, or rewards to the customer, for example, combined data that includes all data related to the customer and the accounts may be more valuable than the filtered, combined data.

FIG. 4 illustrates a portion of a graphical user interface (GUI) 410 of a system 400 for linking account data. In the GUI 410, an “Open Account” ribbon, “Account Search” ribbon, and a “Business Card” ribbon is provided. The Open Account ribbon allows a user to open up an account based on an account number. The Account Search tab allows a user to open multiple accounts and conduct a cross search between accounts. The Business Card Search tab allows a user to conduct an account search, system search, or business search. The user includes customer service representatives, operators, administrators, management, employee, and the like.

In the illustrated embodiment, the user opens a customer account (not shown) and selects the RMG ID listed in the account to open the RMG ID tab. The RMG ID, in some embodiments, is a numerical identifier for a management grouping of related accounts. Thus, the system 400 enables the user to quickly and easily access linked account data.

As further shown in FIG. 4, an RMG ID tab includes a listing of customers names along with the type of customer. A primary customer includes, for example, account holders and joint account holders. A secondary customer includes agents of the primary customer that act on behalf of the account holder. For example, the secondary customer may include entities that are not account holders but have been granted authority by the account holder to act on their behalf. Exemplary secondary customers include brokers, legal guardians, executors, and so forth. Further identified in the customer list are guarantors. The RMG ID tab lists all accounts and customers that are linked together. As described above, the accounts, customers, and guarantors are linked together by a particular customer or account.

The GUI 410 also includes primary contact phone numbers, which designate the type of contact (e.g., home, vacation, cell phone, or work phone numbers), the phone number for each type, the source (i.e., the account name and type), and the account number. In some situations, the user can enter information in the field labeled “Customer Underlying Circumstances.” For example, the user may input for one or more customers the time and date of the input as well as pertinent information for one or more of the customers listed in the RMG ID tab. Information related to a customer such as a change in job status, sale or purchase of a house, upcoming retirement, dates and locations of trips abroad, account closures, account openings, scheduled payments, payment arrangements, and so forth.

Also shown in the GUI 410 of FIG. 4 is a listing of “Relationship Accounts.” The relationship account listing includes, for one or more accounts, the account number, the account name, the purpose of the work being done of the account (e.g., payment recovery for accounts in arrears), address associated with the account, the relationship of the account, the account balance amount, the amount due, the last payment date and amount, the date of birth of the primary customer associated with the account, a portion of the primary customer's government identification, and in internal status code for the account. In the illustrated embodiment, the relationship status for some of the accounts is “lead account.” The lead account includes the account that is most critical to the purpose of the work being done on the account. For example, if the purpose of the work is to offer new financial products to the user, a savings account may be deemed the most critical if the financial products are related to a savings calculator. In the illustrated embodiment, the lead account may include accounts that are in arrears and that have payment due dates that are 90 or more days old and/or that have payment amounts that are above a certain threshold (e.g., the payment due amount is equal to or greater than $1,000).

In some embodiments, customers, contact data, and account data unrelated to guarantors of one or more accounts are not included in the RMG ID tab. By filtering data unrelated to payment recovery, the representative can efficiently and easily analyze the account to determine a proper strategy for contacting the guarantors or otherwise processing payments for the accounts in arrears. In additional or alternative embodiments, other types of data are removed. For example, if the work purpose of the account is to process rewards for a credit card account, then information unrelated to the processing of the rewards would be removed such as accounts that are not credit cards, credit card accounts that do not have an associated reward program, customers not eligible to receive rewards, and the like. Although the primary customers and/or secondary customers are not designated as guarantors, in some embodiments, the primary and/or secondary customers have a guarantor capacity, i.e., the primary and/or secondary customers are at least partially responsible for payment amount due on the account. In other embodiments, the primary and/or secondary customers do not have a guarantor capacity and data associated with the primary and/or secondary customers are retained in the RMG ID tab.

The flowcharts and block diagrams in the Figures illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems which perform the specified functions or acts, or combinations of special purpose hardware and computer instructions.

The terminology used herein is for the purpose of describing particular embodiments only and is not intended to be limiting of embodiments of the disclosure. As used herein, the singular forms “a,” “an,” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present disclosure has been presented for purposes of illustration and description, but is not intended to be exhaustive or limited to embodiments of the disclosure in the form disclosed. Many modifications and variations will be apparent to those of ordinary skill in the art without departing from the scope and spirit of embodiments of the disclosure. The embodiment was chosen and described in order to best explain the principles of embodiments of the disclosure and the practical application, and to enable others of ordinary skill in the art to understand embodiments of the disclosure for various embodiments with various modifications as are suited to the particular use contemplated. Although specific embodiments have been illustrated and described herein, those of ordinary skill in the art appreciate that any arrangement which is calculated to achieve the same purpose may be substituted for the specific embodiments shown and that embodiments of the disclosure have other applications in other environments. This application is intended to cover any adaptations or variations of the present disclosure. The following claims are in no way intended to limit the scope of embodiments of the disclosure to the specific embodiments described herein.

What is claimed is:

1. A system for linking customer accounts, the system comprising:
a computer apparatus including a processor and a memory; and
a linking logic software module stored in the memory, comprising executable instructions that when executed by the processor cause the processor to:
receive account data and non-account data;
filter the account data by customer identification or account identification;
identify a customer and customer accounts associated with the customer based on the filtered account data;
link at least a portion of the non-account data to the customer and combine the non-account data portion and the filtered account data; and
identify one or more guarantors of the customer accounts based on the combined data.

2. The system of claim 1, wherein the executable instructions further cause the processor to:
identify portions of the combined data unrelated to the one or more guarantors; and
filter the identified portions from the combined data.

3. The system of claim 1, wherein the executable instructions further cause the processor to:
re-filter the account data based on the one or more guarantors;
identify at least one additional account associated with the one or more guarantors;
identify an additional guarantor for the at least one additional account;
determine that the additional guarantor is financially responsible for at least a portion of payments for the customer accounts.

4. The system of claim 1, wherein the executable instructions further cause the processor to:
identify a change in customer status;
calculate increases or decreases in inbound or outbound transaction amounts;
determine the amount owed by each of the one or more guarantors based on the calculated increased or decreased amounts.

5. The system of claim 1, wherein the executable instructions further cause the processor to:
match a segment of the filtered account data to a segment of the non-account data portion;
determine the number of matches and type of matches; and
calculate a connection rating based on the number of matches and the type of matches,
wherein the filtered account data and the non-account data portion are combined based on the connection rating.

6. The system of claim 1, wherein the executable instructions further cause the processor to:
calculate the amount each of the one or more guarantors owes based on the combined data;
prioritize the one or more guarantors based on the amount owed; and
create a payment recovery strategy based on the guarantor priority.

7. The system of claim 1, wherein the executable instructions further cause the processor to:
prompt the customer to confirm the identity of the one or more guarantors.

8. The system of claim 1, wherein the executable instructions further cause the processor to:
identify account criteria of other accounts associated with one or more different customers, the account criteria comprising account balances, geographical locations, and account types;
compare the account criteria of the other accounts and the customer accounts;
determine that the other accounts are substantially similar to the customer accounts based on the comparison; and
identify a second guarantor associated with at least one of the other accounts.

9. The system of claim 8, wherein the executable instructions further cause the processor to:
assign the second guarantor to the customer accounts based on the similarity between the other accounts and the customer accounts.

10. The system of claim 8, wherein the executable instructions further cause the processor to:
calculate the percentage of the other accounts that have the second guarantor;
determine that the percentage is above a preselected threshold;
assign the other accounts' guarantor to the customer accounts based on the threshold determination.

11. A computer program product for linking customer accounts, the computer program product comprising:
a computer readable storage medium having computer readable program code embodied therewith, the computer readable program code comprising:
computer readable program code configured to receive account and non-account data;
computer readable program code configured to filter the account data by customer identification or account identification;
computer readable program code configured to identify a customer and customer accounts associated with the customer based on the filtered account data;
computer readable program code configured to link at least a portion of the non-account data to the customer and combine the non-account data portion and the filtered account data; and
computer readable program code configured to identify one or more guarantors of the customer accounts based on the combined data.

12. The computer program product of claim 11, further comprising computer readable program code configured to identify portions of the combined data unrelated to the one or more guarantors; and filter the identified portions from the combined data.

13. The computer program product of claim 11, further comprising computer readable program code configured to re-filter the account data based on the one or more guarantors; identify at least one additional account associated with the one or more guarantors; identify an additional guarantor for the at least one additional account; and determine that the additional guarantor is financially responsible for at least a portion of payments for the customer accounts.

14. The computer program product of claim 11, further comprising computer readable program code configured to identify a change in customer status; calculate increases or decreases in inbound or outbound transaction amounts; and determine the amount owed by each of the one or more guarantors based on the calculated increased or decreased amounts.

15. The computer program product of claim 11, further comprising computer readable program code configured to match a segment of the filtered account data to a segment of the non-account data portion; determine the number of matches and type of matches; and calculate a connection rating based on the number of matches and the type of matches, wherein the filtered account data and the non-account data portion are combined based on the connection rating.

16. The computer program product of claim 11, further comprising computer readable program code configured to calculate the amount each of the one or more guarantors owes based on the combined data; prioritize the one or more guarantors based on the amount owed; and create a payment recovery strategy based on the guarantor priority.

17. A computer-implemented method for linking customer accounts, the method comprising:
receiving account data and non-account data;
filtering, by a processor, the account data by customer identification or account identification;
identifying, by a processor, a customer and customer accounts associated with the customer based on the filtered account data;
linking, by a processor, at least a portion of the non-account data to the customer and combining the non-account data portion and the filtered account data; and
identifying, by a processor, one or more guarantors of the customer accounts based on the combined data.

18. The computer-implemented method of claim 17, further comprising:
identifying portions of the combined data unrelated to the one or more guarantors; and
filtering, by a processor, the identified portions from the combined data.

19. The computer-implemented method of claim 17, further comprising:
re-filtering, by a processor, the account data based on the one or more guarantors;
identifying at least one additional account associated with the one or more guarantors;
identifying an additional guarantor for the at least one additional account;
determining that the additional guarantor is financially responsible for at least a portion of payments for the customer accounts.

20. The computer-implemented method of claim 17, further comprising:
calculating, by a processor, the amount each of the one or more guarantors owes based on the combined data;
prioritizing the one or more guarantors based on the amount owed; and
creating a payment recovery strategy based on the guarantor priority.
